(19) United States
(12) Patent Application Publication
(10) Pub. No.: US 2004/0143504 A1
(43) Pub. Date: Jul. 22, 2004

(54) Purchase order management system and related methods

(76) Inventor: Ming-Fang Tsai, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/748,826

(22) Filed: Dec. 29, 2003

(30) Foreign Application Priority Data
Dec. 25, 2002 (TW) 91137236

(51) Int. Cl. G06F 17/60

(52) U.S. Cl. 705/16

(57) ABSTRACT

A system for purchase order management includes a database server (1), an application server (2), and a number of client computers (4). The database server stores purchase order data. The application server is enabled to access data stored in a sales management system (5), an inventory management system (6) and an accounting management system (7) via a network (3). Each client computer is enabled to visit the application server via the network, and further to access data stored in the database server via the application server. The application server includes a product information maintaining module (20), a customer information maintaining module (21), a product price information maintaining module (22), a shipment information maintaining module (23), a shipment delay managing module (24), a customer complaints managing module (25), and a purchase order reports outputting module (26). Related methods are also disclosed.

### BACKGROUND OF THE INVENTION

1. Field of the Invention

The present invention relates to systems and methods for purchase order management, and particularly to systems and methods for purchase order management according to customers' demands.

2. Description of Related Art

Purchase order management plays an important role in ERP (Enterprise Resource Planning). Purchase order management has been researched and developed for many years. It is widely accepted that how to satisfy customers' demands is a paramount issue in purchase order management.

Traditional purchase order management systems can collect information on sales, inventory and accounting, integrate customer data and product data, select appropriate prices, and generate purchase orders accordingly. A pertinent example is a method for purchase order management as disclosed in P.R. China Patent No. CN1359084A, issued on Jul. 17, 2002 and entitled “Platform For Trade Information Processing And Method For Processing Trade Information.” The patent provides a trade information processing platform for buyers. The platform stores a material requirements database, a supplier database, a material number index database, an inquiry database, and an order database. The platform can generate inquiry bills, quotations and orders according to the information on material requirements, material number indexes and suppliers.

However, the above-described method does not adequately address satisfying customers' demands. In addition, the method cannot be used to manage customer complaints.

### SUMMARY OF THE INVENTION

An object of the present invention is to provide a system and method for purchase order management, in which the system and method can manage purchase orders according to customers' demands.

Another object of the present invention is to provide a system and method for purchase order management, in which the system and method can efficiently manage customer complaints.

To achieve the above-mentioned objects, a preferred embodiment of a system for purchase order management of the present invention comprises a database server and a plurality of client computers connected with an application server. The database server is used for storing customer data, product data, and purchase order data. The application server is used for managing purchase orders according to the customer data, the product data, and the purchase order data. The application server comprises a product information maintaining module for maintaining and integrating information on product; a customer information maintaining module for maintaining and integrating information on customers; a product price information maintaining module for determining a price for each customer; a shipment information maintaining module for scheduling production and shipment of products; a shipment delay managing module for managing delayed purchase orders according to production schedules; a customer complaints managing module for managing customer complaints, deferring shipments, checking the products' qualities, and reproducing the products; and a purchase order reports outputting module for integrating all purchase order information and storing the information in the database server, and for providing an interface for users to enquire of and print the information via the client computers. Each client computer is enabled to visit the application server, and further to access data stored in the database server via the application server.

Further, a preferred method of the present invention for purchase order management comprises the following steps: (a) determining whether a particular customer is an existing customer, and if the customer is an existing customer, enquiring of information on the customer; (b) enquiring of a particular product's information; (c) determining whether the product has price information, and if the product has price information, acquiring the product's price; (d) determining whether the product's total price exceeds the customer's credit limit, and if the total price does not exceed the customer's credit limit, accepting the purchase order; and (e) determining whether inventory is sufficient, and if the inventory is sufficient, determining to dispatch the product.

Still further, a preferred method of the present invention for managing a customer's complaint comprises the following steps: (a) receiving a customer's complaint about products; (b) deferring shipment of the relevant products and arranging for checking of the products; (c) resetting a purchase order; and (d) enquiring whether the customer agrees to reproduction of the products, and if the customer agrees to reproduction of the products, informing a relevant workshop to commence producing the products.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of an application environment including a purchase order management system in accordance with the preferred embodiment of the present invention;

FIG. 2 is a dataflow chart for managing purchase orders in accordance with the present invention;

FIG. 3 is a schematic diagram of software infrastructure of an application server of the system of FIG. 1;

FIG. 4 is a flowchart of a preferred method for operating the system of FIG. 1; and

FIG. 5 is a flowchart of managing a customer's complaint regarding a purchase order.

### DETAILED DESCRIPTION OF THE INVENTION

Reference will now be made to the drawing figures to describe the present invention in detail.

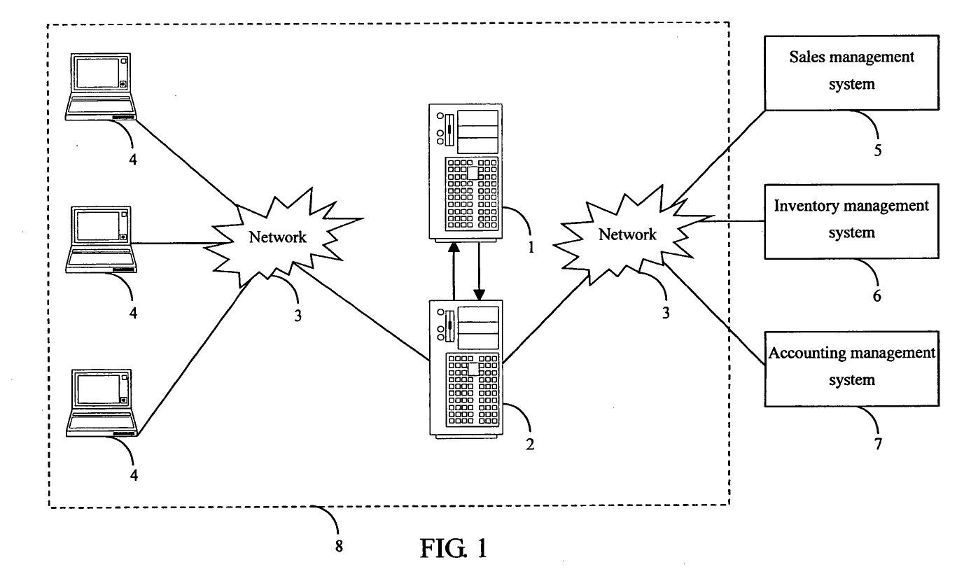

FIG. 1 is a schematic diagram of an application environment including a purchase order management system 8 (hereafter simply referred to as “the system”) in accordance with the preferred embodiment of the present invention. The system comprises a database server 1, an application server 2, and a plurality of client computers 4. The database server 1 stores purchase order data. The application server 2 is enabled to access data stored in a sales management system 5, an inventory management system 6, and an accounting management system 7 via a network 3. Each client computer 4 is enabled to visit the application server 2 via the network 3, and further to access data stored in the database server 1 via the application server 2. The network 3 can be the Internet or an intranet.

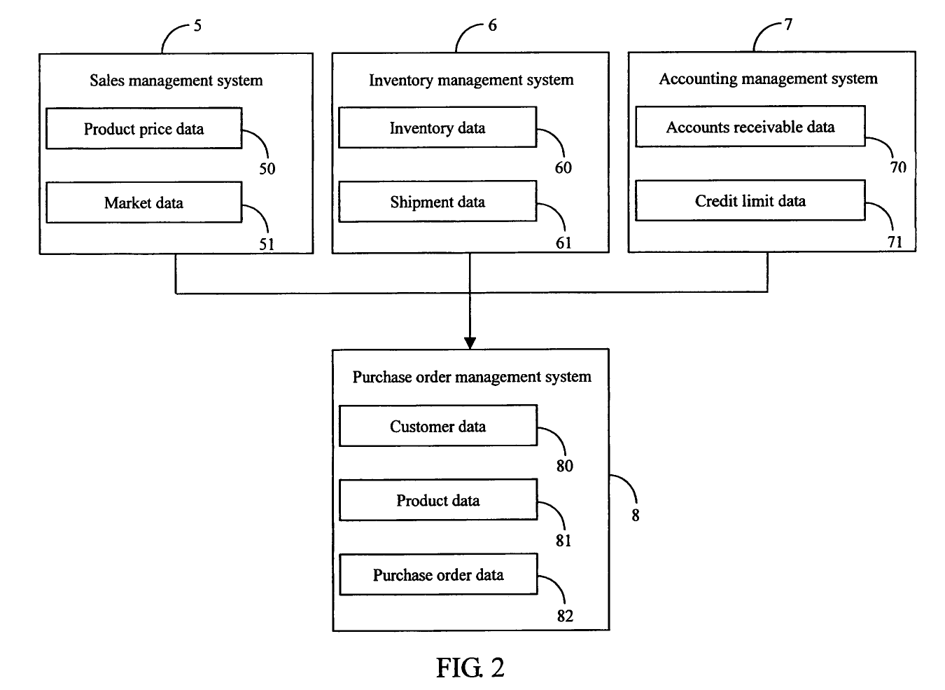

FIG. 2 is a dataflow chart for managing purchase orders in accordance with the present invention. The sales management system 5 stores product price data 50 and market data 51, for providing information on products and corresponding markets. The information on products comprises each product's name, specification, model, production date, and so on. The information on markets comprises each product's market price, other producers, demand and supply data, and so on.

The inventory management system 6 stores inventory data 60 and shipment data 61 for providing information on inventory and shipment. The information on inventory comprises each product's stocks, period in storage to date, person in charge, and so on. The information on shipment comprises each product's shipment amount, shipment date, person in charge, and so on.

The accounting management system 7 stores accounts receivable data 70 and credit limit data 71 for providing information on payment conditions relating to customers. The information on payment conditions relating to customers comprises each customer's performance record, payment records, credit limit, and so on.

The purchase order management system 8 gathers and integrates the data in the sales management system 5, the inventory management system 6 and the accounting management system 7. The purchase order management system 8 stores customer data 80, product data 81, and purchase order data 82 for providing purchase information.

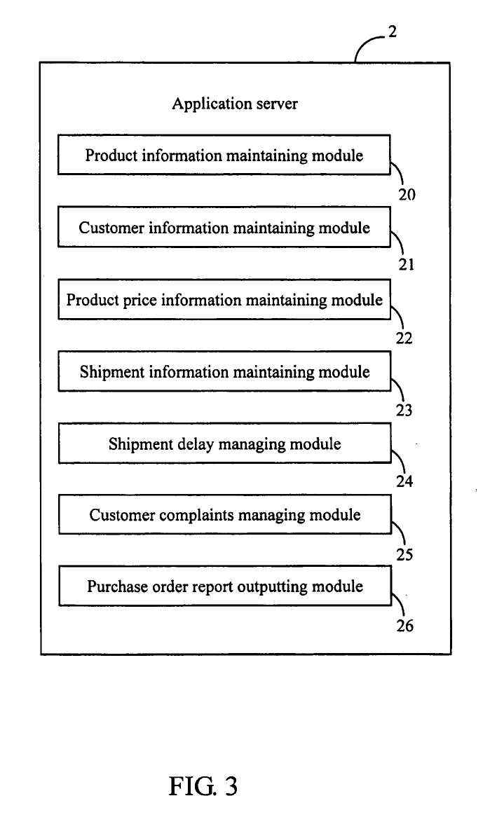

FIG. 3 is a schematic diagram of software infrastructure of the application server 2. The application server 2 comprises a product information maintaining module 20, a customer information maintaining module 21, a product price information maintaining module 22, a shipment information maintaining module 23, a shipment delay managing module 24, a customer complaints managing module 25, and a purchase order reports outputting module 26. The product information maintaining module 20 is used for maintaining and integrating information on products stored in the sales management system 5. The customer information maintaining module 21 is used for maintaining and integrating information on customers based on the credit limit data stored in the accounting management system 7. The product price information maintaining module 22 is used for determining a price for each customer based on the product price data 50 stored in the sales management system 5 and the customer's demand. The shipment information maintaining module 23 is used for scheduling the production and shipment of products according to the inventory data 60 and shipment data 61 stored in the inventory management system 6. The shipment delay managing module 24 is used for managing any delayed purchase order according to the production schedule. The customer complaints managing module 25 is used for managing customer complaints, deferring shipments, and enquiring of any customer as to whether it agrees to reproduction of the products. The purchase order reports outputting module 26 is used for integrating all purchase order information, and storing the information in the database server 1. Users can enquire of and print the information via the client computers 4.

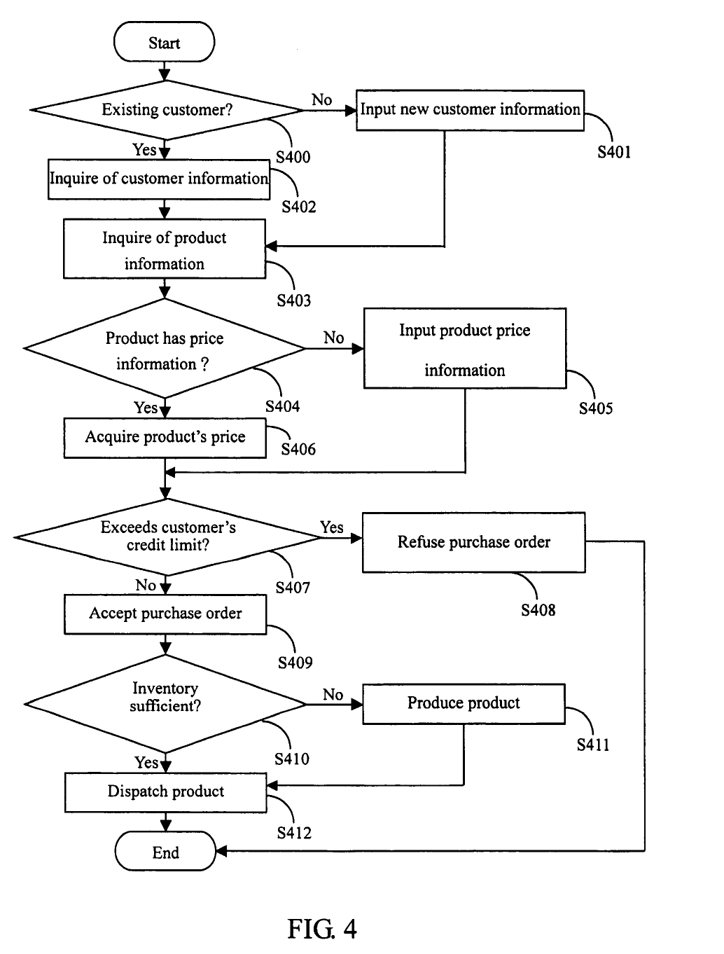

FIG. 4 is a flowchart of a preferred method for operating the system. In step S400, the system determines whether a customer is an existing customer. If the customer is not an existing customer, in step S401, a user inputs the new customer's information, and the customer information maintaining module 21 stores the information in the database 1, whereupon the procedure goes to step S403 described below. If the customer is an existing customer, in step S402, the user enquires of the customer's information via the customer information maintaining module 21. In step S403, the user enquires of a product's information via the product information maintaining module 20. In step S404, the system determines whether the product has price information. If the product has no price information, in step S405, the user inputs the product's price information, and the product price information maintaining module 22 stores said information in the database 1. If the product has price information, in step S406, the user acquires the product's price via the product price information maintaining module 22. In step S407, the system determines whether the total price exceeds the customer's credit limit. If the total price exceeds the customer's credit limit, in step S408, the system refuses the customer's purchase order, whereupon the procedure is ended. If the total price does not exceed the customer's credit limit, in step S409, the system accepts the purchase order. In step S410, the system determines whether inventory is sufficient based on the inventory information. If the inventory is not sufficient, in step S411, the system orders a relevant workshop to produce the needed quantity of the product. If and when the inventory is sufficient, in step S412, the system determines to dispatch the product according to the purchase order.

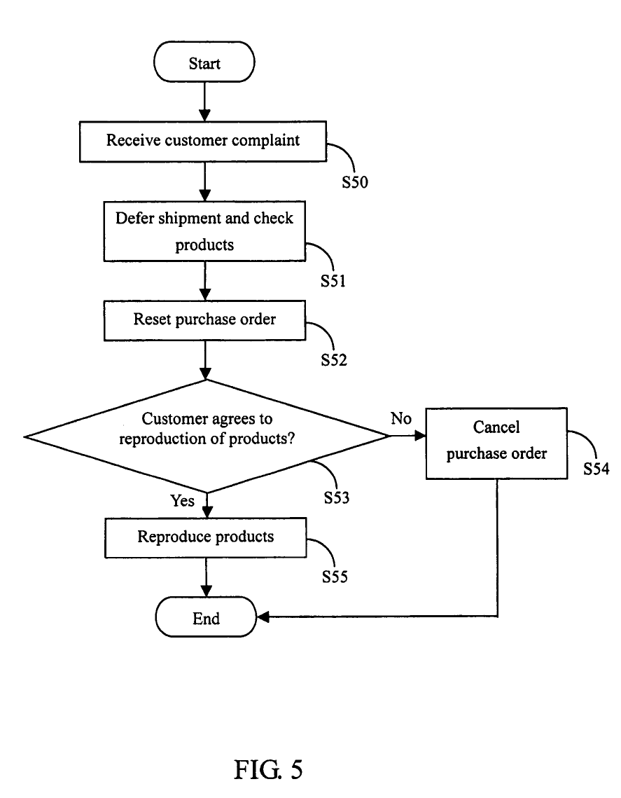

FIG. 5 is a flowchart of a preferred method for managing a customer's complaint regarding a purchase order. In step S50, the application server 2 receives a customer's complaint about products. In step S51, the shipment delay managing module 24 defers shipment of the relevant products, and arranges for checking of the products. This is usually a quality check. In step S52, the application server 2 resets a relevant purchase order, and the purchase order reports outputting module 26 outputs the purchase order to the relevant workshop. In step S53, the customer complaints managing module 25 enquires whether the customer agrees to reproduction of the products. If the customer does not agree to reproduction of the products, in step S54, the customer complaints managing module 25 informs the workshop that the purchase order is canceled, whereupon the procedure is ended. If the customer agrees to reproduction of the products, in step S55, the customer complaints managing module 25 informs the workshop that it can commence reproducing the products according to the purchase order.

In general, the system and related methods of the present invention may take forms other those described above. While preferred embodiments for carrying out the invention have been described in detail, those familiar with the art to which the invention relates will recognize various alternative designs and embodiments for practicing the invention. These alternative embodiments are within the scope of the present invention. The scope of the present invention is defined by the claims appended hereto and allowable equivalents thereof.

What is claimed is:

1. A system for purchase order management, the system comprising a database server and a plurality of client computers connected with an application server, wherein:
the database server is used for storing customer data, product data, and purchase order data;
the application server is used for managing purchase orders according to the customer data, the product data and the purchase order data, the application server comprising:
a product information maintaining module for maintaining and integrating information on products;
a customer information maintaining module for maintaining and integrating information on customers;
a product price information maintaining module for determining a price for each customer; and
a shipment information maintaining module for scheduling production and shipment of products; and
each of the client computers is enabled to visit the application server, and further to access data stored in the database server via the application server.

2. The system for purchase order management as described in claim 1, wherein the application server further comprises a shipment delay managing module for managing delayed purchase orders according to production schedules.

3. The system for purchase order management as described in claim 1, wherein the application server further comprises a customer complaints managing module for managing customer complaints, deferring shipments, and enquiring whether the customer agrees to reproduce the products.

4. The system for purchase order management as described in claim 1, wherein the application server further comprises a purchase order reports outputting module for integrating all purchase order information and storing the information in the database server.

5. A method for purchase order management, the method comprising the following steps:
determining whether a customer is an existing customer, and if the customer is an existing customer, enquiring of information on the customer;
enquiring of information on a product;
determining whether the product has price information, and if the product has price information, acquiring the product's price;
determining whether a total purchase price of the product exceeds the customer's credit limit, and if the total purchased price does not exceed the customer's credit limit, accepting the purchase order; and
determining whether inventory of the product is sufficient, and if the inventory is sufficient, determining to dispatch the product.

6. The method for purchase order management as described in claim 5, further comprising the step of inputting and storing information on a new customer, if the customer is not an existing customer.

7. The method for purchase order management as described in claim 5, further comprising the step of inputting and storing price information on the product, if the product has no price information.

8. The method for purchase order management as described in claim 5, further comprising the step of refusing the customer's purchase order, if the total price exceeds the customer's credit limit.

9. The method for purchase order management as described in claim 5, further comprising the step of ordering a relevant workshop to produce the product, if the inventory is not sufficient.

10. A method for managing a customer's complaint, the method comprising the following steps:
receiving a customer's complaint about products;
deferring shipment of the relevant products, and checking the products;
resetting a purchase order; and
enquiring whether the customer agrees to reproduction of the products, and if the customer agrees to reproduction of the products, informing a relevant workshop to commence producing the products.

11. The method for managing a customer's complaint as described in claim 10, further comprising the step of outputting the reset purchase order to the workshop.

12. The method for managing a customer's complaint as described in claim 11, further comprising the step of informing the workshop that the purchase order is canceled, if the customer does not agree to reproduction of the products.
